(19) United States
(12) Patent Application Publication
(10) Pub. No.: US 2019/0224895 A1
(43) Pub. Date: Jul. 25, 2019

(54) GEAR, GEAR TRANSMISSION MECHANISM AND MANUFACTURING METHOD OF GEAR

(71) Applicants: DENSO CORPORATION, Aichi (JP); NIDEC SANKYO CORPORATION, Nagano (JP)

(72) Inventors: Makoto INOMATA, Aichi (JP); Tatsuya SASAKI, Aichi (JP); Yoshinori OGAWA, Nagano (JP)

(21) Appl. No.: 16/300,525

(22) PCT Filed: Apr. 18, 2017
(86) PCT No.: PCT/JP2017/015543

§ 371 Date: Nov. 9, 2018

(30) Foreign Application Priority Data
May 26, 2016 (JP) 2016-104761

(51) Int. Cl. B29C 45/27; B29C 70/04; F16H 1/06; F16H 27/08; F16H 55/06; F16H 55/17

(52) U.S. Cl. CPC B29C 45/27; B29C 70/04; F16H 55/17; F16H 27/08; F16H 55/06; F16H 1/06

(57) ABSTRACT

In a gear comprising a resin material including a fibrous filler, a plurality of teeth formed at equal angular intervals are provided to a first outer peripheral part. When the gear is manufactured, the resin material is filled from a specific portion (first toothless part) which faces in a direction orthogonal to a center axis line, and in which the teeth are not formed in a portion that overlaps the first outer peripheral part when seen from the direction orthogonal to the center axis line. Therefore, there is a gate mark in the specific portion. Between the specific portion and the center axis line, the degree to which the filler is oriented in a direction intersecting the center axis line is higher than the degree to which the filler is oriented in a direction running along the center axis line.

### TECHNICAL FIELD

The present invention relates to a gear made of resin, a gear transmission mechanism and a manufacturing method of a gear made of resin.

### BACKGROUND ART

In the geared motor, rotation of a motor is outputted through a gear transmission mechanism (see Patent Literature 1). In this case, a large force is applied to a gear and thus, when the gear is to be resin molded, it has been proposed that resin material containing fibrous fillers such as a carbon fiber or a glass fiber is used (see Patent Literature 2).

### CITATION LIST

### Patent Literature

[PTL 1] Japanese Patent Laid-Open No. 2013-44351

[PTL 2] Japanese Utility Model Laid-Open No. Sho 63-83676

### SUMMARY OF INVENTION

### Technical Problem

In a molded article using resin material containing fibrous fillers, a bending elastic modulus in an orientation direction of fillers is higher than that in a direction perpendicular to the orientation direction of the fillers. However, as described in FIG. 2 of Patent Literature 2, in a case that a gate is disposed at an end part of a rotation center shaft when the gear is to be molded, the orientation direction of the fillers cannot be controlled in a disk part where teeth are formed and thus strength in a direction intersecting a center axial line of the disk part cannot be increased.

In view of the problem described above, an objective of the present invention is to provide a gear, a gear transmission mechanism and a manufacturing method of a gear, in which strength of a portion where gear teeth are formed can be increased in a direction perpendicular to a center axial line.

### Means to Solve the Problems

To solve the above mentioned problem, the present invention provides a gear made of resin material containing fillers in a fiber shape, and the gear is provided with a first outer peripheral part having a plurality of first teeth formed at equal angle intervals and, when viewed in a direction perpendicular to a center axial line, a gate mark is left in a specific portion where the first teeth are not formed and which faces a direction perpendicular to the center axial line in a portion overlapping with the first outer peripheral part.

In other words, a gear in accordance with another aspect of the present invention is made of resin material containing fillers in a fiber shape, the gear is provided with a first outer peripheral part having a plurality of first teeth formed at equal angle intervals, and a degree of orientation of the fillers in a direction intersecting the center axial line is higher than a degree of orientation of the fillers in a direction along the center axial line between a specific portion where the first teeth are not formed and which faces a direction perpendicular to the center axial line in a portion overlapping with the first outer peripheral part and the center axial line when viewed in a direction perpendicular to a center axial line.

In a case that a gear in accordance with the present invention is to be manufactured, when viewed in a direction perpendicular to a center axial line, a gate is disposed in a specific portion where the first teeth are not formed and which faces a direction perpendicular to the center axial line in a portion overlapping with the first outer peripheral part, and resin material containing fibrous fillers is filled in a cavity in a die through the gate. As a result, in the fillers, a degree of orientation in a direction intersecting the center axial line from a side where the specific portion is located becomes higher than a degree of orientation in a direction along the center axial line between the specific portion where the gate is disposed and the center axial line. Therefore, a bending elastic modulus of a portion where the first teeth are formed becomes larger in a direction perpendicular to the center axial line in comparison with a case that a gate is disposed in a portion which faces the axial direction. Accordingly, when a bending stress is applied in the direction perpendicular to the center axial line to the portion where the first teeth are formed, for example, the bending distortion is small and a strength can be increased in a direction applied to a portion where the teeth are formed (direction perpendicular to the center axial line) when rotation is transmitted.

In the gear in accordance with the present invention, it may be structured that the first outer peripheral part is provided with a first toothless part where the first teeth are not formed, and the gate mark is left on the first toothless part. In other words, in the gear in accordance with another aspect of the present invention, it may be structured that the first outer peripheral part is provided with a first toothless part where the first teeth are not formed, and the specific portion is located on the first toothless part. According to this structure, the present invention can be easily applied to a gear whose rotation range is less than one rotation.

In the gear in accordance with the present invention, it may be structured that a second outer peripheral part adjacent to the first outer peripheral part in a direction of the center axial line is provided with a plurality of second teeth formed at equal angle intervals, a curvature radius of the second outer peripheral part is larger than a curvature radius of the first outer peripheral part, the second outer peripheral part is provided with a cut-out part as a second toothless part where the second teeth are not formed in the same angle direction as the first toothless part, and the gate mark is continuously left from the first toothless part to the second toothless part. In other words, in the gear in accordance with another aspect of the present invention, it may be structured that a second outer peripheral part adjacent to the first outer peripheral part in a direction of the center axial line is provided with a plurality of second teeth formed at equal angle intervals, a curvature radius of the second outer peripheral part is larger than a curvature radius of the first outer peripheral part, the second outer peripheral part is provided with a cut-out part as a second toothless part where the second teeth are not formed in the same angle direction as the first toothless part, and the specific portion is continuously provided from the first toothless part to the second toothless part. The second outer peripheral part is formed with the second toothless part as a cut-out part and thus, even in a case that a curvature radius of the second outer peripheral part is larger than that of the first outer peripheral part, a gate can be continuously disposed from the first toothless part to the second toothless part. Therefore, a gate is disposed in a specific portion where the second teeth are not formed and which faces a direction perpendicular to the center axial line in a portion overlapping with the second outer peripheral part when viewed in a direction perpendicular to the center axial line. As a result, also in the second outer peripheral part, in the fillers, a degree of orientation in a direction intersecting the center axial line from a side where the specific portion is located becomes higher than a degree of orientation in a direction along the center axial line between the specific portion where the gate is disposed and the center axial line. Therefore, a bending elastic modulus of a portion where the second teeth are formed becomes larger in a direction perpendicular to the center axial line in comparison with a case that a gate is disposed in a portion which faces the axial direction. Accordingly, when a bending stress is applied in the direction perpendicular to the center axial line to the portion where the second teeth are formed, for example, the bending distortion is small and a strength can be increased in a direction applied to a portion where the teeth are formed (direction perpendicular to the center axial line) when rotation is transmitted.

In the gear in accordance with the present invention, it may be structured that the gear is provided with a hole which is concentrically provided with the first outer peripheral part on an inner side in a radial direction of the first outer peripheral part, and the gate mark is left on an inner peripheral face of the hole. In other words, in the gear in accordance with another aspect of the present invention, it may be structured that the gear is provided with a hole which is concentrically provided with the first outer peripheral part on an inner side in a radial direction of the first outer peripheral part, and the specific portion is located on an inner peripheral face of the hole. According to these structures, also in a gear whose entire periphery is formed with teeth, a degree of orientation of the fillers can be increased in the direction intersecting the center axial line.

The present invention provides a gear transmission mechanism including a plurality of gears, and at least one of the plurality of the gears is made of resin material containing fillers in a fiber shape, the one of the plurality of the gears is provided with a plurality of first teeth formed at equal angle intervals in a first outer peripheral part and, when viewed in a direction perpendicular to a center axial line, a gate mark is left in a specific portion where the first teeth are not formed and which faces a direction perpendicular to the center axial line in a portion overlapping with the first outer peripheral part. In other words, another aspect of the present invention provides a gear transmission mechanism including a plurality of gears, and at least one of the plurality of the gears is made of resin material containing fillers in a fiber shape, the one of the plurality of the gears is provided with a plurality of first teeth formed at equal angle intervals in a first outer peripheral part, and a degree of orientation of the fillers in a direction intersecting the center axial line is higher than a degree of orientation of the fillers in a direction along the center axial line between a specific portion where the first teeth are not formed and which faces a direction perpendicular to the center axial line in a portion overlapping with the first outer peripheral part and the center axial line when viewed in a direction perpendicular to a center axial line.

A manufacturing method of a gear in accordance with the present invention is characterized in that, in order to manufacture a gear provided with a plurality of first teeth formed at equal angle intervals in a first outer peripheral part by filling resin material containing fillers in a fiber shape into a cavity in a die, when viewed in a direction perpendicular to a center axial line, a gate is disposed on an inner face of the cavity in a specific portion where the first teeth are not formed and which faces a direction perpendicular to the center axial line in a portion overlapping with the first outer peripheral part.

### Advantageous Effects of Invention

In a case that a gear in accordance with the present invention is to be manufactured, when viewed in a direction perpendicular to a center axial line, a gate is disposed in a specific portion where the first teeth are not formed and which faces a direction perpendicular to the center axial line in a portion overlapping with the first outer peripheral part, and resin material containing fibrous fillers is filled in a cavity in a die through the gate. As a result, in the fillers, a degree of orientation in a direction intersecting the center axial line from a side where the specific portion is located becomes higher than a degree of orientation in a direction along the center axial line between the specific portion where the gate is disposed and the center axial line. Therefore, a bending elastic modulus of a portion where the first teeth are formed becomes larger in a direction perpendicular to the center axial line in comparison with a case that a gate is disposed in a portion which faces the axial direction. Accordingly, when a bending stress is applied in the direction perpendicular to the center axial line to the portion where the first teeth are formed, for example, the bending distortion is small, and a strength can be increased in a direction applied to a portion where the teeth are formed (direction perpendicular to the center axial line) when rotation is transmitted.

### BRIEF DESCRIPTION OF THE DRAWINGS

FIG. 1 is a perspective view showing an entire structure of a geared motor to which the present invention is applied.

FIG. 2 is an enlarged perspective view showing a fourth gear in FIG. 1.

FIG. 3 is an enlarged perspective view showing a fifth gear in FIG. 1.

FIG. 4 is a cross-sectional view schematically showing a manufacturing method of the fourth gear shown in FIG. 2.

FIGS. 5A and 5B are explanatory views showing an orientation state of fillers in the fourth gear shown in FIG. 2.

FIG. 6 is an explanatory view showing an orientation state of fillers in the fifth gear shown in FIG. 3.

FIG. 7 is a graph showing a relationship between a flowing direction (orientation direction of filler) of resin material and a bending elastic modulus at respective temperatures in a molded article produced of resin material containing fibrous fillers.

FIG. 8 is a perspective view showing a modified embodiment of the fourth gear to which the present invention is applied.

FIGS. 9A and 9B are explanatory views showing an orientation state of fillers in the fourth gear shown in FIG. 8.

FIG. 10 is a perspective view showing the first gear in FIG. 1 to which the present invention is applied.

### DESCRIPTION OF EMBODIMENTS

In order to describe one example of a gear, a gear transmission mechanism and a manufacturing method of a gear to which the present invention is applied, a gear and a gear transmission mechanism provided in a geared motor will be described below with reference to the accompanying drawings.

### (Entire Structure of Geared Motor)

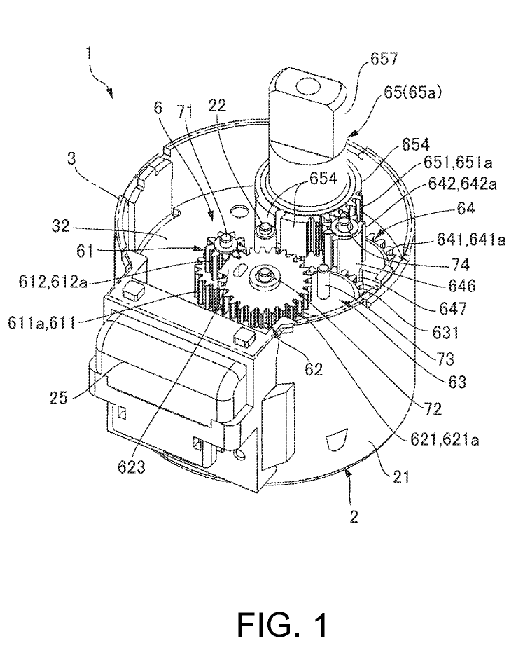

FIG. 1 is a perspective view showing an entire structure of a geared motor to which the present invention is applied. In FIG. 1, a cover 3 is shown with an alternate long and short dash line so as to visually recognize a gear transmission mechanism 6.

In FIG. 1, a geared motor 1 includes a motor 2 provided with a structure of a stepping motor, a terminal part 25 for supplying electric power to the motor 2 from the outside, and a gear transmission mechanism 6 structured of a plurality of gears 61, 62, 63, 64 and 65 which transmit rotation of the motor 2. The geared motor 1 includes a plate-shaped cover 3, which closes an opening of a motor case 21 so as to cover the gear transmission mechanism 6, and a support plate 32 which supports the gear transmission mechanism 6 between the support plate 32 and the cover 3. The gears 61, 62, 63 and 64 of the gears 61, 62, 63, 64 and 65 are disposed between the support plate 32 and the cover 3. A motor pinion (not shown) of a rotor (not shown) which is rotatably supported by a support shaft 22 is protruded from the support plate 32.

### (Schematic Structure of Gear Transmission Mechanism 6)

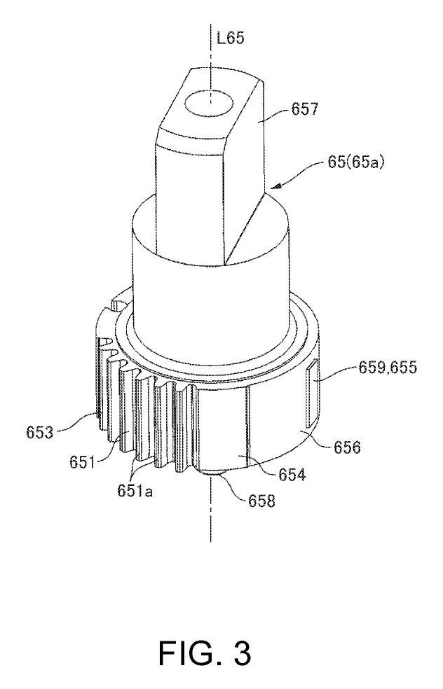

The gear 65 of a final stage of the gear transmission mechanism 6 is structured as an output member 65a provided with an output shaft 657, and the output shaft 657 is protruded from the cover 3. In the gear transmission mechanism 6, four gears 61, 62, 63 and 64 except the gear 65 of the final stage are respectively rotatably supported by support shafts 71, 72, 73 and 74 whose both ends are supported by the support plate 32 and the cover 3. In the gear 65 of the final stage, an output shaft 657 and a shaft part 658 (see FIG. 3) formed itself are respectively rotatably supported by a bearing part (not shown) on a side of the cover 3 and a bearing part (not shown) of the support plate 32.

The gears 61, 62, 63 and 64 are composite gears each of which is integrally formed of a large diameter gear part and a small diameter gear part. A large diameter gear part 611 of the first gear 61 viewed from the motor pinion 24 is engaged with the motor pinion, and a small diameter gear part 612 of the gear 61 is engaged with a large diameter gear part 621 of the second gear 62. A small diameter gear part (not shown) of the gear 62 is engaged with a large diameter gear part 631 of the third gear 63, and a small diameter gear part (not shown) of the gear 63 is engaged with a large diameter gear part 641 of the fourth gear 64. A small diameter gear part 642 of the gear 64 is engaged with a gear part 651 of the gear 65 of the final stage. In this manner, the gear transmission mechanism 6 is structured as a speed reduction gear train. The gears 61, 62, 63, 64 and 65 are gears made of resin composed of polyphenylene sulfide, polyacetal, polybutylene terephthalate, polyamide, or the like. Further, at least the gears 61, 64 and 65 are made of composite resin material obtained by dispersing fibrous fillers such as carbon fibers, glass fibers or the like to the above-mentioned resin material.

In the geared motor 1, when electric power is supplied to the motor 2 and the rotor is rotated, the rotation is transmitted to the output member 65a (gear 65) through the motor pinion 24, the gear 61, the gear 62, the gear 63 and the gear 64. In this case, the motor 2 is rotated in both directions and, according to the rotation, the output member 65a (gear 65) is reciprocatively turned over a predetermined angular range.

In the gear 61, although the small diameter gear part 612 is formed with teeth 612a over the entire circumference, the large diameter gear part 621 of the gear 62 is formed with a toothless part 623 where a tooth 621a is not formed. In this embodiment, the toothless part 623 is structured as a protruded part which is protruded in a radial direction and thus the toothless part 623 functions as a stopper part which stops rotation of the gear 61 of a former stage. Therefore, a rotation range of the gear 62 is less than one rotation and rotation ranges of the gear 64 and the gear 65 are also less than one rotation.

### (Structure of Gear 64)

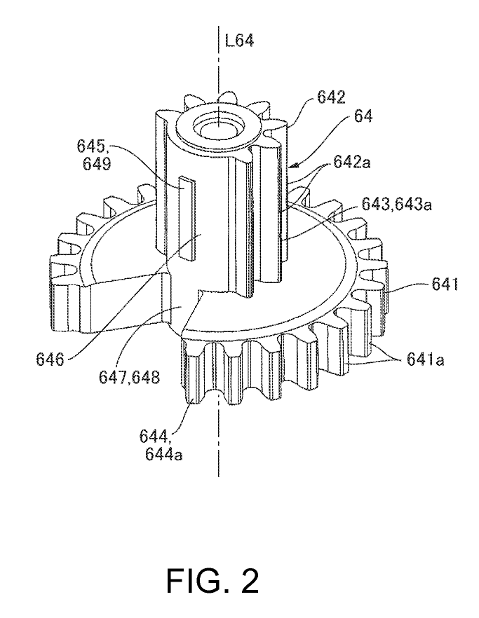

FIG. 2 is an enlarged perspective view showing the fourth gear 64 in FIG. 1. As shown in FIG. 2, the gear 64 is provided with the small diameter gear part 642 formed on an outer peripheral part (first outer peripheral part 643) of a cylindrical tube part 643a and the large diameter gear part 641 formed on an outer peripheral part (second outer peripheral part 644) of a disk part 644a which is continuously connected with the cylindrical tube part 643a. The small diameter gear part 642 is formed with a plurality of teeth 642a (first teeth) at equal angle intervals and the large diameter gear part 641 is formed with a plurality of teeth 641a (second teeth) at equal angle intervals. A curvature radius of the second outer peripheral part 644 (disk part 646a) is larger than a curvature radius of the first outer peripheral part 643 (cylindrical tube part 643a).

In this embodiment, a rotation range of the gear 64 is less than one rotation. Therefore, the first outer peripheral part 643 is formed with the teeth 642a only on a part in a circumferential direction at equal angle intervals, and the first outer peripheral part 643 is formed with a first toothless part 646 which is a circumferential face where the teeth 642a are not formed. Further, the second outer peripheral part 644 is, similarly to the first outer peripheral part 643, also formed with the teeth 641a only on a part in a circumferential direction at equal angle intervals, and the second outer peripheral part 644 is formed with a second toothless part 647 where the teeth 641a are not formed. In this embodiment, a portion corresponding to the second toothless part 647 is formed to be a cut-out part 648 which is cut out in a fan shape.

In this embodiment, the first outer peripheral part 643 and the second outer peripheral part 644 are adjacent to each other in a center axial line “L64” direction of the gear 64. Further, the first toothless part 646 and the second toothless part 647 are formed in the same angle direction. In addition, a curvature radius of the first toothless part 646 and a curvature radius of the second toothless part 647 (curvature radius of a bottom part of the cut-out part 648) are equal to each other. Therefore, the first toothless part 646 and the second toothless part 647 structure a continuous surface.

### (Structure of Gear 65)

FIG. 3 is an enlarged perspective view showing the fifth gear 65 in FIG. 1. In this embodiment, a rotation range of the gear 65 is less than one rotation. Therefore, as shown in FIG. 3, in the gear 65, a gear part 651 is formed with teeth 651a (first teeth) at equal angle intervals only on a part in a circumferential direction, and an outer peripheral part 653 (first outer peripheral part) formed with the gear part 651 is structured with a toothless part 656 (first toothless part) which is a circumferential face where the teeth 651a are not formed. In the toothless part 656, both end parts in the circumferential direction are formed with a protruded part 654 protruded in the radial direction. The protruded part 654 functions as a stopper part structured to stop turning of the gear 64 of a preceding stage.

### (Manufacturing Method and Detailed Structure of Gear 64)

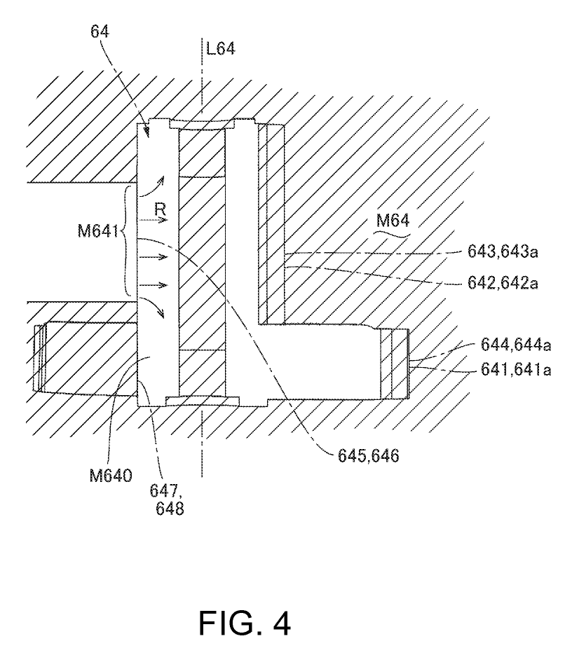

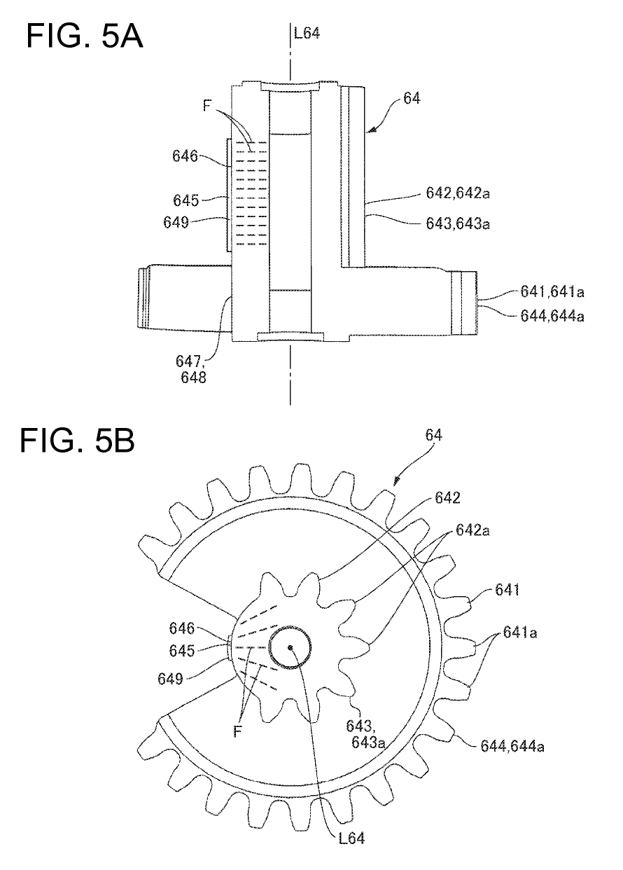

FIG. 4 is a cross-sectional view schematically showing a manufacturing method of the fourth gear 64 shown in FIG. 2. FIGS. 5A and 5B are explanatory views showing an orientation state of fillers in the fourth gear 64 shown in FIG. 2. FIG. 5A corresponds to a cross section when the gear 64 is cut along the center axial line “L64”, and FIG. 5B corresponds to a cross section when the gear 64 is cut by a face perpendicular to the center axial line “L64” at a position passing the first outer peripheral part 643.

The gear 64 described with reference to FIG. 2 is a resin molded article manufactured by a method described below with reference to FIG. 4 by using resin material containing fibrous fillers such as a carbon fiber or a glass fiber. In the gear 64, a gate mark 649 is left in a specific portion 645 where the teeth 642a (first tooth) are not formed and which faces the direction perpendicular to the center axial line “L64” in a portion overlapping with the first outer peripheral part 643 when viewed in the direction perpendicular to the center axial line “L64”. In this embodiment, the specific portion 645 is an outer peripheral face of the cylindrical tube part 643a located in the first toothless part 646.

In a manufacturing process of the gear 64 in this embodiment, as shown in FIG. 4, resin material containing fibrous fillers is filled into a cavity “M640” in a die “M64” constituted of a plurality of shapes to manufacture the gear 64 provided with a plurality of the teeth 641a formed at equal angle intervals on the first outer peripheral part 643. In this case, in an inner face of the cavity “M640”, a gate “M641” is disposed in the specific portion 645 (first toothless part 646) where the teeth 642a (first tooth) are not formed and which faces the direction perpendicular to the center axial line “L64” in a portion overlapping with the first outer peripheral part 643 when viewed in the direction perpendicular to the center axial line “L64”.

Therefore, resin material containing fibrous fillers is, as shown by the arrows “R” in FIG. 4, filled into the cavity “M640” through the gate “M641” in the direction perpendicular to the center axial line “L64”. Further, after molding is performed, when the gear 64 is recovered from the cavity “M640” of the die “M64”, a gate mark 649 is left in the specific portion 645 of the gear 64 where the teeth 642a (first tooth) are not formed and which faces the direction perpendicular to the center axial line “L64”.

Further, the resin material is filled into the cavity “M640” through the gate “M641” in the direction perpendicular to the center axial line “L64” and thus, as shown in FIGS. 5A and 5B, the fillers “F” are oriented from a side where the specific portion 645 is located (from a side where the gate mark 649 is located) in the direction perpendicular to the center axial line “L64” in the vicinity of the specific portion 645. As a result, in the fillers “F”, an oriented degree in the direction intersecting the center axial line “L64” is higher than an oriented degree in a direction along the center axial line “L64” at least between the specific portion 645 of the first outer peripheral part 643 (cylindrical tube part 643a) and the center axial line “L64”. Further, also in other portions separated from the specific portion 645 such as the second outer peripheral part 644 (disk part 644a) of the gear 64, a degree of orientation of the fillers “F” in the direction intersecting the center axial line “L64” becomes higher in comparison with a case that the resin material is filled in a direction along the center axial line “L64”.

### (Manufacturing Method and Detailed Structure of Gear 65)

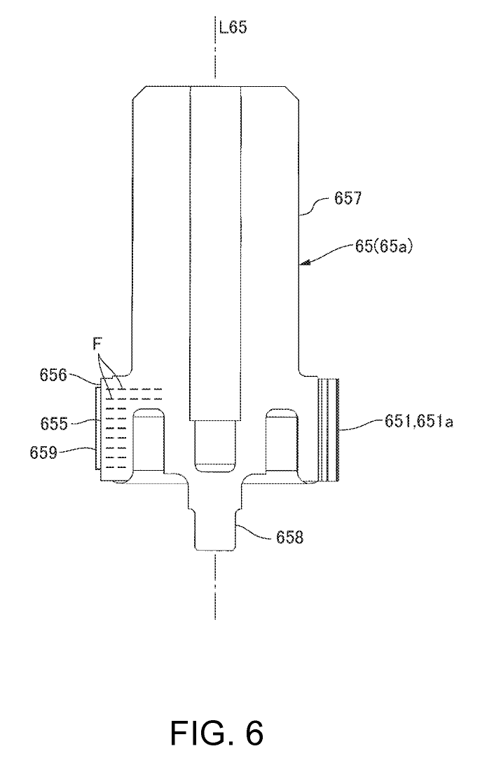

FIG. 6 is an explanatory view showing an orientation state of fillers in the fifth gear 65 shown in FIG. 3 and corresponds to a cross section when the gear 65 is cut along the center axial line “L65”. Although not shown, also in a case that the gear 65 described with reference to FIG. 3 is to be manufactured, similarly to the case that the gear 64 is to be manufactured, resin material containing fibrous fillers is filled into a cavity in a die constituted of a plurality of shapes to manufacture the gear 65 provided with a plurality of the teeth 651a formed at equal angle intervals on the outer peripheral part 653. In this case, in an inner face of the cavity, a gate is disposed in the specific portion 655 (toothless part 656) where the teeth 651a (first tooth) are not formed and which faces the direction perpendicular to the center axial line “L65” in a portion overlapping with the outer peripheral part 653 when viewed in the direction perpendicular to the center axial line “L65”. Therefore, resin material containing fibrous fillers is filled into the cavity through the gate in the direction perpendicular to the center axial line “L65”. Further, after molding is performed, when the gear 65 is recovered from the cavity of the die, as shown in FIG. 3, a gate mark 659 is left in the specific portion 655 (toothless part 656) of the gear 65 where the teeth 651a are not formed and which faces the direction perpendicular to the center axial line “L65” in a portion overlapping with the outer peripheral part 653 when viewed in the direction perpendicular to the center axial line “L65”.

Further, the resin material is filled into the cavity through the gate in the direction perpendicular to the center axial line “L65” and thus, as shown in FIG. 6, in the vicinity of the specific portion 655, the fillers “F” are oriented in the direction perpendicular to the center axial line “L65” from a side where the specific portion 655 is located (from a side where the gate mark 659 is located). As a result, in the fillers “F”, an oriented degree in the direction intersecting the center axial line “L65” is higher than an oriented degree in the direction along the center axial line “L65” at least between the specific portion 655 and the center axial line “L65”. Further, also in other portions separated from the specific portion 655 of the gear 65, a degree of orientation of the fillers “F” in the direction intersecting the center axial line “L65” becomes higher in comparison with a case that the resin material is filled in the direction along the center axial line “L65”.

### Principal Effects in this Embodiment

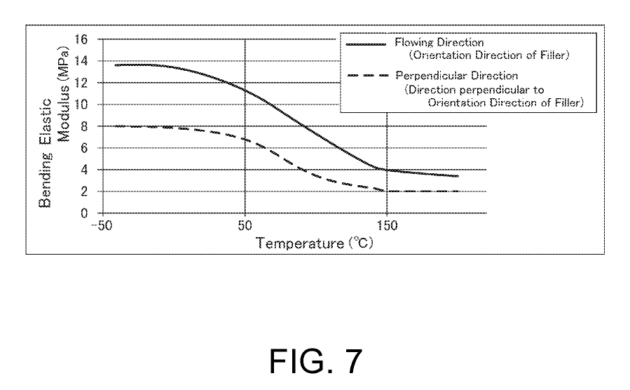

FIG. 7 is a graph showing a relationship between a flowing direction (orientation direction of filler) of resin material and a bending elastic modulus at respective temperatures in a molded article produced of resin material containing fibrous fillers. In FIG. 7, a bending elastic modulus in a flowing direction of resin material (direction where the filler is oriented) is indicated by the solid line, and a bending elastic modulus in a perpendicular direction to the flowing direction of resin material (direction perpendicular to the direction where the filler is oriented) is indicated by the broken line.

As described above, in the gear 64 in this embodiment, as described with reference to FIG. 4 and FIGS. 5A and 5B, the resin material is filled into the cavity “M640” through the gate “M641” in the direction perpendicular to the center axial line “L64” and thus, a degree of orientation of the fillers “F” in the direction intersecting the center axial line “L64” is higher than a degree of orientation in the direction along the center axial line “L64” between a side where the specific portion 645 is located (side where the gate mark 649 is located) and the center axial line “L64”. Further, also in other portions of the gear 64, a degree of orientation of the fillers “F” in the direction intersecting the center axial line “L64” becomes higher in comparison with a case that the resin material is filled in the direction along the center axial line “L64”.

In a molded article produced of resin material containing fibrous fillers, when a bending elastic modulus in a flowing direction of resin material (direction where the filler is oriented) is compared for each temperature with a bending elastic modulus in a perpendicular direction to the flowing direction of resin material (direction perpendicular to the direction where the filler is oriented), the tendency as shown in FIG. 7 is indicated. As shown in FIG. 7, the bending elastic modulus in the direction where the fillers are oriented (see the solid line) is larger than the bending elastic modulus in the direction perpendicular to the direction where the fillers are oriented (see the broken line) at any temperature. Further, a stress transmitted when the gear 64 is rotated is applied in a direction perpendicular to the center axial line “L64” and thus, in this embodiment, in a case that rotation of the gear 64 is transmitted, it can be said that a degree of orientation of the fillers is high in the direction to which a stress is applied. Therefore, in the gear 64, when a bending stress is applied in the direction perpendicular to the center axial line “L64” to the first outer peripheral part 643 (cylindrical tube part 643a) where the teeth 642a are formed, the bending distortion is small. Accordingly, in the gear 64, a strength in a direction applied to a portion where the teeth 642a are formed (direction perpendicular to the center axial line “L64”) when rotation is transmitted can be increased.

Further, in this embodiment, also in the gear 65, similarly to the gear 64, a degree of orientation of the fillers is high in the direction to which a stress is applied when rotation of the gear 65 is transmitted. Therefore, also in the gear 65, similarly to the gear 64, when a bending stress is applied in the direction perpendicular to the center axial line “L65” to the portion where the teeth 651a are formed, the bending distortion is small. Accordingly, a strength of the gear 65 in a direction applied to a portion where the teeth 651a are formed (direction perpendicular to the center axial line “L65”) when rotation is transmitted can be increased.

### [Modified Embodiment of Gear 64]

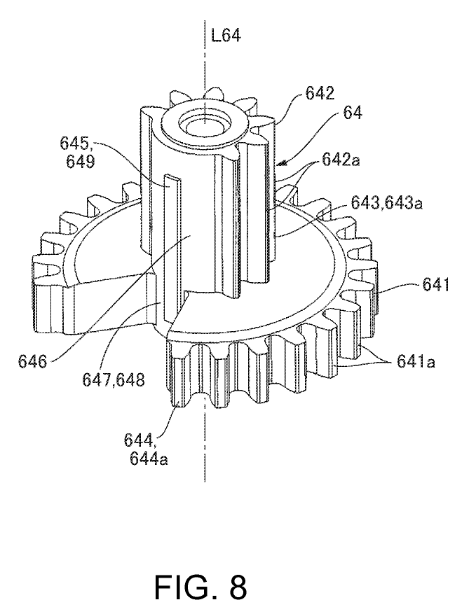

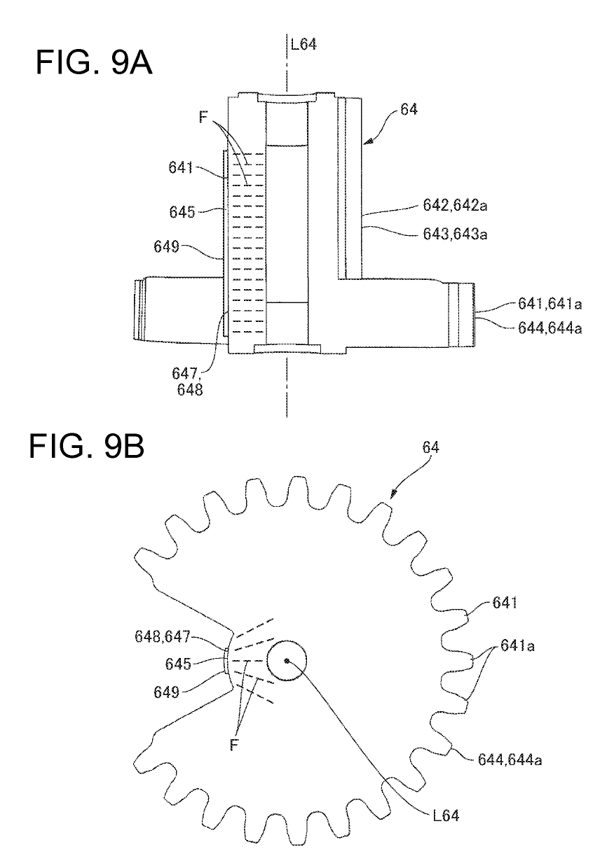

FIG. 8 is a perspective view showing a modified embodiment of the fourth gear 64 to which the present invention is applied. FIGS. 9A and 9A are explanatory views showing an orientation state of fillers in the fourth gear 64 shown in FIG. 8. FIG. 8A corresponds to a cross section when the gear 64 is cut along the center axial line “L64”, and FIG. 8B corresponds to a cross section when the gear 64 is cut by a face perpendicular to the center axial line “L64” at a position passing the second outer peripheral part 644.

As shown in FIG. 8, in the gear 64, a curvature radius of the second outer peripheral part 644 is larger than a curvature radius of the first outer peripheral part 643, but a portion corresponding to a second toothless part 647 is formed to be a cut-out part 478 which is cut in a fan shape. Therefore, the first toothless part 646 and the second toothless part 647 structure a continuous surface. Accordingly, in this embodiment, when resin is to be molded, a gate is disposed in a range from the first toothless part 646 to the second toothless part 647. As a result, a gate mark 649 is continuously extended from the first toothless part 646 to the second toothless part 647.

According to this structure, in a case that resin is to be molded, when viewed in the center axial line “L64” direction, resin material is filled in a direction perpendicular to the center axial line “L64” in both of the first outer peripheral part 643 and the second outer peripheral part 644. Therefore, as shown in FIGS. 9A and 9B, in the vicinity of the specific portion 655 (gate mark 649), the fillers “F” are oriented in a direction perpendicular to the center axial line “L64” from a side where the specific portion 645 is located (from a side where the gate mark 649 is located) in both of the first outer peripheral part 643 and the second outer peripheral part 644. Accordingly, in the fillers “F”, an oriented degree in the direction intersecting the center axial line “L64” is higher than an oriented degree in the direction along the center axial line “L64” between the specific portion 645 and the center axial line “L64”. As a result, in the gear 64, when a bending stress is applied in the direction perpendicular to the center axial line “L64”, the bending distortion is small in both of the portion where the teeth 641a are formed and the portion where the teeth 642a are formed. Accordingly, a strength of the gear 64 can be increased in a direction applied to the portions where the teeth 641a and 642a are formed (direction perpendicular to the center axial line “L64”) when rotation is transmitted.

### (Manufacturing Method and Detailed Structure of Gear 61)

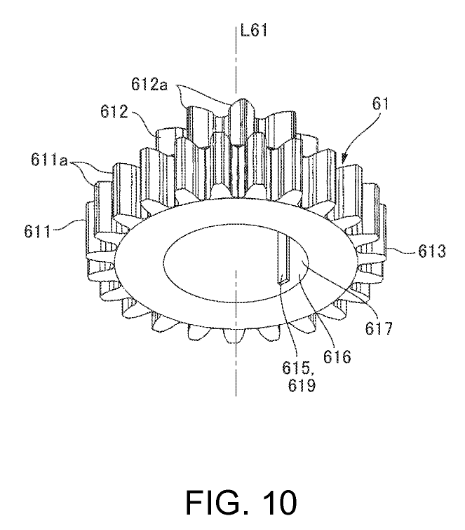

FIG. 10 is a perspective view showing the first gear 61 in FIG. 1 to which the present invention is applied. In the embodiments described above, the toothless parts are provided in the gears 64 and 65 in order to dispose a gate in a specific portion where teeth are not formed and which faces the direction perpendicular to the center axial line. On the other hand, the gear 61 is formed with teeth 611a and 612a over the entire periphery and no toothless part is provided.

Therefore, in this embodiment, as shown in FIG. 10, the gear 61 is provided with a circular hole 616 which is concentrically formed with the outer peripheral part 613 on an inner side in a radial direction of the outer peripheral part 613 where the teeth 611a are formed, and a gate is disposed on an inner peripheral face 617 of the hole 616 to manufacture the gear 61. Therefore, in the gear 61, when viewed in a direction perpendicular to a center axial line “L61” of the gear 61, a gate can be disposed in a specific portion 615 (inner peripheral face 617 of the hole 616) where the teeth 611a are not formed and which faces the direction perpendicular to the center axial line “L61” in a portion overlapping with the outer peripheral part 613, and a gate mark 619 is left in the specific portion 615.

Also in the case structured as described above, when resin is to be molded, resin material is filled in a direction perpendicular to the center axial line “L61”. Therefore, in the vicinity of the specific portion 615 (gate mark 619), the fillers are oriented in the direction perpendicular to the center axial line “L61” from a side where the specific portion 615 is located (side where the gate mark 619 is located). As a result, in the fillers “F”, a degree of orientation in the direction intersecting the center axial line “L61” is higher than a degree of orientation in the direction along the center axial line “L61” between the specific portion 615 and the center axial line “L61”. Further, also in other portions of the gear 61, a degree of orientation of the fillers “F” in the direction intersecting the center axial line “L61” becomes higher in comparison with a case that the resin material is filled in the direction along the center axial line “L61”. Therefore, in the gear 61, when a bending stress is applied in the direction perpendicular to the center axial line “L61” to a portion where the teeth 611a are formed, the bending distortion is small. Accordingly, a strength in a direction applied to a portion where the teeth 611a are formed (direction perpendicular to the center axial line) when rotation is transmitted can be increased.

### Other Embodiments

In the embodiments described above, the present invention is applied to the gear which is used in the gear transmission mechanism 6 of the geared motor 1. However, the present invention may be applied to a gear of a gear transmission mechanism which is separately provided from a motor.

1. A gear made of resin material containing fillers in a fiber shape, the gear comprising a first outer peripheral part comprising a plurality of first teeth formed at equal angle intervals;
wherein when viewed in a direction perpendicular to a center axial line, a gate mark is left in a specific portion where the first teeth are not formed and which faces a direction perpendicular to the center axial line in a portion overlapping with the first outer peripheral part.

2. The gear according to claim 1, wherein the first outer peripheral part comprises a first toothless part where the first teeth are not formed, and the gate mark is left on the first toothless part.

3. The gear according to claim 2, further comprising a plurality of second teeth which are formed at equal angle intervals in a second outer peripheral part adjacent to the first outer peripheral part in a direction of the center axial line,
wherein a curvature radius of the second outer peripheral part is larger than a curvature radius of the first outer peripheral part,
wherein the second outer peripheral part comprises a cut-out part as a second toothless part where the second teeth are not formed in a same angle direction as the first toothless part, and
wherein the gate mark is continuously left from the first toothless part to the second toothless part.

4. The gear according to claim 1, further comprising a hole which is concentrically provided with the first outer peripheral part on an inner side in a radial direction of the first outer peripheral part, wherein the gate mark is left on an inner peripheral face of the hole.

5. A gear made of resin material containing fillers in a fiber shape, the gear comprising a first outer peripheral part comprising a plurality of first teeth formed at equal angle intervals;
wherein a degree of orientation of the fillers in a direction intersecting the center axial line is higher than a degree of orientation of the fillers in a direction along the center axial line between a specific portion where the first teeth are not formed and which faces a direction perpendicular to the center axial line in a portion overlapping with the first outer peripheral part and the center axial line when viewed in the direction perpendicular to the center axial line.

6. The gear according to claim 5, wherein the first outer peripheral part comprises a first toothless part where the first teeth are not formed, and the specific portion is located on the first toothless part.

7. The gear according to claim 6, further comprising a plurality of second teeth which are formed at equal angle intervals in a second outer peripheral part adjacent to the first outer peripheral part in a direction of the center axial line,
wherein a curvature radius of the second outer peripheral part is larger than a curvature radius of the first outer peripheral part,
wherein the second outer peripheral part comprises a cut-out part as a second toothless part where the second teeth are not formed in a same angle direction as the first toothless part, and
wherein the specific portion is continuously provided from the first toothless part to the second toothless part.

8. The gear according to claim 5, further comprising a hole which is concentrically provided with the first outer peripheral part on an inner side in a radial direction of the first outer peripheral part, wherein the specific portion is located on an inner peripheral face of the hole.

9. The gear according to claim 5, wherein a gate mark is left on the specific portion.

10. A gear transmission mechanism comprising a plurality of gears, wherein
at least one of the plurality of the gears is made of resin material containing fillers in a fiber shape,
the one of the plurality of the gears comprises a plurality of first teeth formed at equal angle intervals in a first outer peripheral part, and
when viewed in a direction perpendicular to a center axial line, a gate mark is left in a specific portion where the first teeth are not formed and which faces a direction perpendicular to the center axial line in a portion overlapping with the first outer peripheral part.

11. A gear transmission mechanism comprising a plurality of gears, wherein
at least one of the plurality of the gears is made of resin material containing fillers in a fiber shape,
the one of the plurality of the gears comprises a plurality of first teeth formed at equal angle intervals in a first outer peripheral part, and
a degree of orientation of the fillers in a direction intersecting the center axial line is higher than a degree of orientation of the fillers in a direction along the center axial line between a specific portion where the first teeth are not formed and which faces a direction perpendicular to the center axial line in a portion overlapping with the first outer peripheral part and the center axial line when viewed in a direction perpendicular to a center axial line.

12. A manufacturing method of a gear in which resin material containing fillers in a fiber shape is filled into a cavity in a die to manufacture a gear provided with a plurality of first teeth formed at equal angle intervals in a first outer peripheral part, wherein when viewed in a direction perpendicular to a center axial line, a gate is disposed on an inner face of the cavity in a specific portion where the first teeth are not formed and which faces a direction perpendicular to the center axial line in a portion overlapping with the first outer peripheral part.

13. The gear according to claim 6, wherein a gate mark is left on the specific portion.

14. The gear according to claim 7, wherein a gate mark is left on the specific portion.

15. The gear according to claim 8, wherein a gate mark is left on the specific portion.
